(19) United States
(12) Patent Application Publication
(10) Pub. No.: US 2023/0242722 A1
(43) Pub. Date: Aug. 3, 2023

(54) Method for Producing Long Optical Film Containing Polyimide-Based Resin

(71) Applicants: Sumitomo Chemical Company, Limited, Tokyo (JP); Zymergen Inc., Emeryville, CA (US)

(72) Inventors: Takashi Sakurai, Ibaraki (JP); Takeru Shimoyama, Ibaraki (JP); Arjan Zoombelt, Emeryville, CA (US); Justin Kerszulis, Emeryville, CA (US)

(73) Assignees: Sumitomo Chemical Company, Limited, Tokyo (JP); Zymergen Inc., Emeryville, CA (US)

(21) Appl. No.: 18/013,081

(22) PCT Filed: Jul. 1, 2021
(86) PCT No.: PCT/JP2021/025022

§ 371 Date: Dec. 27, 2022

(30) Foreign Application Priority Data
Jul. 2, 2020 (JP) 2020-115182

(51) Int. Cl. C08J 5/18; C09D 179/08; G02B 1/10

(52) U.S. Cl. CPC C08J 5/18; C09D 179/08; G02B 1/10; C08J 2379/08

(57) ABSTRACT

The present invention relates to a method for producing a long optical film, the method comprising a step for preparing a varnish by dissolving a polyimide-based resin in a solvent, wherein the polyimide-based resin contains a constitutional unit derived from an aliphatic diamine, and a moisture absorption speed per unit area of the solvent is 25% by mass/h·m² or less as determined by a Karl Fischer method.

### TECHNICAL FIELD

The present invention relates to a method for producing a long optical film comprising a polyimide-based resin.

### BACKGROUND ART

As optical films for use in various applications including display devices such as liquid crystal displays and OLEDs, touch sensors, speakers, and semiconductors, polyimide-based films are known. As a method for producing such a film, for example, a method is known in which a polyimide-based resin film is produced by forming a coating film from a polyimide-based resin composition comprising a polyimide-based resin and an organic solvent such as N,N-dimethylacetamide, γ-butyrolactone, or m-cresol (for example, Patent Documents 1 and 2).

### PRIOR ART DOCUMENTS

### Patent Documents

Patent Document 1: JP 2007-231224 A

Patent Document 2: WO 2019/156717 A

### SUMMARY OF THE INVENTION

### Problems to be Solved by the Invention

Commonly, when a polyimide-based optical film is produced, the film is produced by cast forming in which a coating liquid is applied and dried. However, the present inventors have found that when an attempt is made to produce a long film by the methods described in Patent Documents 1 and 2, irregularities are likely to occur on the surface and the appearance is poor, and therefore the resulting film is not necessarily sufficient as an optical film, which is required to have high smoothness.

Therefore, an object of the present invention is to provide a method for producing a long optical film comprising a polyimide-based resin, the film having high smoothness and good appearance.

### Means for Solving the Problems

When the present inventors studied the cause of the phenomenon that when an attempt was made to produce the long optical film by a conventional method, irregularities are generated on a surface of the film to deteriorate the appearance, they found that a solvent to be used in the production of a long optical film absorbs a relatively large amount of moisture and a resulting coating film has an increased amount of moisture absorbed. Furthermore, it was found that when the amount of moisture absorbed of the solvent increases, liquid separation occurs in the process of forming a coating film, whereby irregularities are generated on the film surface in a drying step involving evaporation of the solvent and the film appearance is deteriorated. In order to solve this problem, the present inventors studied a method for controlling the moisture absorption amount of a coating film, and as a result, found that the above problem can be solved when the moisture absorption speed per unit area of the solvent to be used in a step of preparing a varnish is 25% by mass/h·m² or less, and thus have accomplished the present invention. That is, the present invention encompasses the following preferred embodiments.

[1] A method for producing a long optical film, the method comprising a step of preparing a varnish by dissolving a polyimide-based resin in a solvent, wherein the polyimide-based resin comprises a constitutional unit derived from an aliphatic diamine, and a moisture absorption speed per unit area of the solvent is 25% by mass/h·m² or less determined by a Karl Fischer method.
[2] The method according to [1], wherein the solvent comprises at least one selected from a group consisting of cyclohexanone and cyclopentanone.
[3] The method according to [1] or [2], wherein the long optical film has a glass transition temperature Tg of higher than 180° C.
[4] The method according to any one of [1] to [3], wherein the long optical film has an optical transmittance at 350 nm of 10% or less.
[5] The method according to any one of [1] to [4], wherein the long optical film has an optical transmittance at 500 nm of 90% or more.
[6] The method according to any one of [1] to [5], wherein the long optical film has a tensile strength of more than 86 MPa.
[7] A long optical film comprising a polyimide-based resin, wherein the polyimide-based resin comprises a constitutional unit derived from an aliphatic diamine, and the long optical film has a maximum height roughness Rz defined by JIS B-0601: 2013 of 2.0 μm or less on at least one surface thereof.
[8] A long optical film comprising a polyimide-based resin, wherein the polyimide-based resin comprises a constitutional unit derived from an aliphatic diamine, and the long optical film has a maximum height roughness Rz defined by JIS B-0601: 2013 of 2.0 μm or less on a surface which has not been in contact with a substrate of the long optical film.
[9] The long optical film according to [7] or [8], wherein the long optical film has a thickness retardation Rth of 100 nm or less.
[10] The long optical film according to any one of [7] to [9], wherein the long optical film has a solvent content of 3.0% by mass or less based on a mass of the long optical film.
[11] The long optical film according to any one of [7] to [10], wherein the polyimide-based resin comprises a constitutional unit represented by Formula (1)

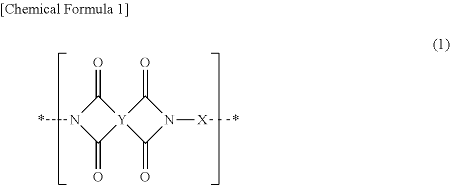

wherein X represents a divalent aliphatic group, Y represents a tetravalent organic group, and * represents a bonding hand.
[12] The long optical film according to [11], wherein the constitutional unit represented by Formula (1) comprises, as Y, a structure represented by Formula (2)

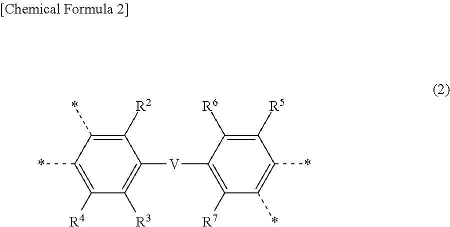

wherein R² to R⁷ each independently represent a hydrogen atom, an alkyl group having 1 to 6 carbon atoms, an alkoxy group having 1 to 6 carbon atoms, or an aryl group having 6 to 12 carbon atoms, the hydrogen atoms contained in R² to R⁷ may be each independently substituted by a halogen atom, V represents a single bond, —O—, —CH₂—, —CH₂—, —CH₂—, —CH(CH₃)—, —C(CH₃)₂—, —C(CF₃)₂—, —SO₂—, —S—, —CO—, or —N(R⁸)—, R⁸ represents a hydrogen atom or a monovalent hydrocarbon group having 1 to 12 carbon atoms which is optionally substituted with a halogen atom, and * represents a bonding hand.
[13] The long optical film according to [11] or [12], wherein the polyimide-based resin contains a fluorine atom.

### Effects of the Invention

According to the present invention, it is possible to provide a method for producing a long optical film comprising a polyimide-based resin, the film having high smoothness and good appearance.

### EMBODIMENTS OF THE INVENTION

The method for producing a long optical film of the present invention comprises a step of preparing a varnish by dissolving a polyimide-based resin in a solvent, wherein the polyimide-based resin comprises a constitutional unit derived from an aliphatic diamine, and a moisture absorption speed per unit area of the solvent is 25% by mass/h·m² or less as determined by a Karl Fischer method.

### [Solvent]

The moisture absorption speed per unit area of the solvent to be used for preparing the varnish as determined by the Karl Fischer method is 25% by mass/h·m² or less, preferably 22% by mass/h·m² or less, more preferably 20% by mass/h·m² or less, and particularly preferably 18% by mass/h·m² or less. The moisture absorption speed per unit area is preferably 1% by mass/h·m² or more, more preferably 1.5% by mass/h·m² or more, and still more preferably 2% by mass/h·m² or more. When the moisture absorption speed per unit area exceeds 25% by mass/h·m², it may be difficult to obtain a film having high smoothness and good appearance. When the moisture absorption speed per unit area is within the above range, it is easy to obtain a film having high smoothness and good appearance.

In the present description, the moisture absorption speed per unit area as determined by the Karl Fischer method can be measured as follows. A solvent (40 mL) is put in a plastic container with a volume of 100 mL (bottom diameter: 45 mm, opening diameter: 50 mm) and held for 30 minutes or 60 minutes in an environment with a temperature of 22.0° C. and a relative humidity of 30% RH. After holding for a prescribed time, the entire solvent is stirred with a spatula for 1 to 2 seconds, and the stirred solvent is transferred to a glass bottle having a volume of 10 mL to fill the glass bottle, and the glass bottle is sealed to afford a solvent sample. Under the same atmosphere as described above, a moisture absorption speed per hour (% by mass/h) is determined from water amounts at 30 minutes and 60 minutes determined by a volumetric titration method using a Karl Fischer coulometric moisture analyzer (“831”, “832” (manufactured by Metrohm Corporation)), and a value obtained by dividing the moisture absorption speed per hour by the area of the solvent in contact with the atmosphere, that is, the area of the opening of the plastic container is defined as the moisture absorption speed per unit area.

In the present invention, the solvent is preferably a ketone-based solvent, more preferably a cyclic ketone-based solvent, further preferably one or more solvents selected from the group consisting of cyclohexanone, cyclopentanone, 2-methylcyclohexanone, 3-methylcyclohexanone, and 4-methylcyclohexanone, and particularly preferably one or more solvents selected from the group consisting of cyclohexanone and cyclopentanone. These solvents may be used singly or two or more of them may be used in combination. In addition, the above-described solvents may be used in combination with solvents other than the above-described solvents, and in this case, the amount of the solvents other than the above-described solvents is preferably 50% by mass or less, more preferably 40% by mass or less, still more preferably 30% by mass or less, and particularly preferably 20% by mass or less based on the total mass of the solvents. Examples of the solvents other than those described above include alcohol-based solvents such as methanol, ethanol, ethylene glycol, isopropyl alcohol, propylene glycol, ethylene glycol methyl ether, ethylene glycol butyl ether, 1-methoxy-2-propanol, 2-butoxyethanol, and propylene glycol monomethyl ether; ketone-based solvents such as acetone, methyl ethyl ketone, 2-heptanone, and methyl isobutyl ketone; acyclic ester-based solvents such as ethyl acetate, butyl acetate, ethylene glycol methyl ether acetate, propylene glycol methyl ether acetate, and ethyl lactate; ether-based solvents such as tetrahydrofuran and dimethoxyethane; and phenol-based solvents such as phenol and cresol. The solid content concentration of the varnish is preferably 1 to 30% by mass, more preferably 5 to 25% by mass, and still more preferably 10 to 20% by mass from the viewpoint of easily adjusting the viscosity of the varnish to a viscosity at which the varnish is easily handled. In the present description the solid content of the varnish refers to the total amount of the components resulting from excluding the solvent from the varnish. The viscosity of the varnish is preferably 5 to 300 Pa s, and more preferably 10 to 280 Pa s. When the viscosity of the varnish is within the above range, the long optical film is easily made uniform, the appearance of the long optical film is easily improved, and a long optical film superior in optical characteristics and tensile strength is easily obtained. The viscosity of the varnish can be measured using a viscometer, and can be measured by, for example, the method described in EXAMPLES.

When the polyimide-based resin is dissolved in a solvent to prepare a varnish, the stirring time is preferably 1 to 48 hours, more preferably 3 to 48 hours, and still more preferably 6 to 48 hours. The stirring can be carried out under any temperature and humidity conditions, but in order to reduce excessive moisture absorption of the varnish, the stirring is preferably carried out with the inside of the container purged with an inert gas.

The method of the present invention may comprise, in addition to the above-described step of preparing a varnish by dissolving the polyimide-based resin in a solvent, for example, a step of applying the varnish to a substrate to form a coating film (application step) and a step of drying the coating film to form a long optical film (long optical film formation step).

Examples of the substrate to be used in the application step include a glass substrate, a PET film, a PEN film, and a film of another polyimide-based resin or a polyamide-based resin. Among them, glass, a PET film, and a PEN film are preferable from the viewpoint of superior heat resistance, and a glass substrate or a PET film is more preferable from the viewpoint of adhesion to the optical film and cost.

Examples of the method of applying the varnish to the substrate include publicly-known application methods such as a lip coating method, a spin coating method, a dipping method, and a spraying method, a bar coating method, and a die coating method. From the viewpoint of controlling the film thickness and the residual solvent amount, for example, a die coating method is preferable in which a coating film having a prescribed film thickness is formed by feeding a varnish to a die and discharging the varnish from the die at a constant pressure and a constant speed.

The thickness of the coating film is preferably 50 μm or more, more preferably 100 μm or more, still more preferably 200 μm or more, and is preferably 2000 μm or less, more preferably 1500 μm or less, and still more preferably 1000 μm or less. When the thickness of the coating film is within the above range, a film having good appearance tends to be obtained.

In the long optical film formation step, for example, the coating film is dried and peeled off from the substrate, whereby a long film can be formed.

In the method of the present invention, the drying of the coating film can be carried out by a publicly-known method. Examples of such a drying method include a method using a hot air machine, an infrared heater, or the like. Alternatively, as in a coater facility, the formation and the drying of the coating film can be carried out with a single machine. The drying may be carried out only from the air surface (surface not in contact with the substrate) direction of the coating film, only from the substrate side, or from both the directions.

The drying in the long optical film formation step is carried out at a temperature of preferably 50 to 200° C., and more preferably 80 to 200° C. The drying time is preferably 5 to 60 minutes, and more preferably 10 to 30 minutes. When the temperature and time are as described above, it is easy to obtain a film having high smoothness and good appearance. The coating film may be dried under an inert atmosphere condition, as necessary. When the drying is carried out under vacuum conditions, minute bubbles may be generated and remain in the film, which causes poor appearance of the film, and therefore it is preferable to dry the coating film under atmospheric pressure.

An additional drying step of further drying the film after the peeling may be carried out. The additional drying can be carried out usually at a temperature of 100 to 200° C., and preferably 150 to 200° C. In a preferred embodiment, it is preferable to carry out the drying stepwise. A varnish containing a high molecular weight resin tends to have a high viscosity, and it is generally difficult to obtain a uniform film, so that it may be impossible to obtain a film superior in transparency. Therefore, by carrying out the stepwise drying, the varnish containing the high molecular weight resin can be uniformly dried, and the transparency can be improved.

### [Polyimide-Based Resin]

The term “polyimide-based resin” means a polymer comprising a repeating structural unit (also referred to as a constitutional unit) containing an imide group, and may further comprise a repeating structural unit containing an amide group.

In the present invention, the polyimide-based resin comprises a constitutional unit derived from an aliphatic diamine. The aliphatic diamine represents a diamine having an aliphatic group, and may contain other substituents as a part of the structure thereof, but does not have any aromatic ring. When the polyimide-based resin comprises a constitutional unit derived from an aliphatic diamine, the long optical film produced by the method of the present invention has good heat resistance, optical characteristics, and tensile strength. Examples of the aliphatic diamine include acyclic aliphatic diamines and cyclic aliphatic diamines, and from the viewpoint of easily improving heat resistance, optical characteristics, and tensile strength, acyclic aliphatic diamines are preferable. Examples of the acyclic aliphatic diamine include linear or branched diaminoalkanes having 2 to 10 carbon atoms such as 1,2-diaminoethane, 1,3-diaminopropane, 1,4-diaminobutane, 1,5-diaminopentane, 1,6-diaminohexane, 1,2-diaminopropane, 1,2-diaminobutane, 1,3-diaminobutane, 2-methyl-1,2-diaminopropane, and 2-methyl-1,3-diaminopropane. Examples of the cyclic aliphatic diamine include 1,3-bis(aminomethyl)cyclohexane, 1,4-bis(aminomethyl)cyclohexane, norbornanediamine, and 4,4′-diaminodicyclohexylmethane. These may be used singly or two or more of them may be used in combination. Among these, from the viewpoint of easily improving optical characteristics, heat resistance, and tensile strength, diaminoalkanes having 2 to 10 carbon atoms such as 1,2-diaminoethane, 1,3-diaminopropane, 1,4-diaminobutane (also referred to as 1,4-DAB), 1,5-diaminopentane, 1,6-diaminohexane, 1,2-diaminopropane, 1,2-diaminobutane, 1,3-diaminobutane, 2-methyl-1,2-diaminopropane, and 2-methyl-1,3-diaminopropane are preferable, diaminoalkanes having 2 to 6 carbon atoms are more preferable, and 1,4-diaminobutane is still more preferable. In the present description, the optical characteristics mean optical characteristics of a long optical film including a retardation, transparency, and a UV-blocking property, and the improvement or enhancement of the optical characteristics means, for example, a decrease in retardation, an increase in optical transmittance at 500 nm (or an increase in transparency), a decrease in optical transmittance at 350 nm (or an increase in UV-blocking property), and the like, and the superior optical characteristics mean a low retardation, a high optical transmittance at 500 nm (or a high transparency), and a low optical transmittance at 350 nm (or a high UV-blocking property).

The polyimide-based resin may comprise a constitutional unit derived from an aromatic diamine in addition to the constitutional unit derived from an aliphatic diamine. The aromatic diamine represents a diamine having an aromatic ring, and may contain an aliphatic group or other substituents as a part of the structure thereof. The aromatic ring may be either a single ring or a fused ring, and examples thereof include, but are not limited to, a benzene ring, a naphthalene ring, an anthracene ring, and a fluorene ring.

Examples of the aromatic diamine include aromatic diamines having one aromatic ring such as p-phenylenediamine, m-phenylenediamine, 2,4-toluenediamine, m-xylylenediamine, p-xylylenediamine, 1,5-diaminonaphthalene, and 2,6-diaminonaphthalene, and aromatic diamines having two or more aromatic rings such as 4,4′-diaminodiphenylmethane, 4,4′-diaminodiphenylpropane, 4,4′-diaminodiphenyl ether, 3,4′-diaminodiphenyl ether, 3,3′-diaminodiphenyl ether, 4,4′-diaminodiphenylsulfone, 3,4′-diaminodiphenylsulfone, 3,3′-diaminodiphenylsulfone, 1,4-bis(4-aminophenoxy)benzene, 1,3-bis(4-aminophenoxy)benzene, bis[4-(4-aminophenoxy)phenyl]sulfone, bis[4-(3-aminophenoxy)phenyl]sulfone, 2,2-bis[4-(4-aminophenoxy)phenyl]propane, 2,2-bis[4-(3-aminophenoxy)phenyl]propane, 2,2′-dimethylbenzidine, 2,2′-bis(trifluoromethyl)-4,4′-diaminodiphenyl (also referred to as TFMB), 4,4′-(hexafluoropropylidene)dianiline, 4,4′-bis(4-aminophenoxy)biphenyl, 9,9-bis(4-aminophenyl)fluorene, 9,9-bis(4-amino-3-methylphenyl)fluorene, 9,9-bis(4-amino-3-chlorophenyl)fluorene, and 9,9-bis(4-amino-3-fluorophenyl)fluorene. These may be used singly or two or more of them may be used in combination.

The polyimide-based resin can further comprise a constitutional unit derived from a tetracarboxylic acid compound. When the constitutional unit derived from a tetracarboxylic acid compound is contained, heat resistance, optical characteristics, and tensile strength are easily improved. Examples of the tetracarboxylic acid compound include aromatic tetracarboxylic acid compounds such as aromatic tetracarboxylic dianhydrides; and aliphatic tetracarboxylic acid compounds such as aliphatic tetracarboxylic dianhydrides. The tetracarboxylic acid compounds may be used singly or two or more of them may be used in combination. Besides the dianhydride, the tetracarboxylic acid compound may be a tetracarboxylic acid compound analogue such as an acid chloride compound.

Examples of the aromatic tetracarboxylic dianhydride include non-fused polycyclic aromatic tetracarboxylic dianhydrides, monocyclic aromatic tetracarboxylic dianhydrides, and fused polycyclic aromatic tetracarboxylic dianhydrides. Examples of the non-fused polycyclic aromatic tetracarboxylic dianhydride include 4,4′-oxydiphthalic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride (also referred to as BPDA), 2,2′,3,3′-biphenyltetracarboxylic dianhydride, 3,3′,4,4′-diphenylsulfonetetracarboxylic dianhydride, 2,2-bis(3,4-dicarboxyphenyl)propane dianhydride, 2,2-bis(2,3-dicarboxyphenyl)propane dianhydride, 2,2-bis(3,4-dicarboxyphenoxyphenyl)propane dianhydride, 4,4′-(hexafluoroisopropylidene)diphthalic dianhydride (also referred to as 6FDA), 1,2-bis(2,3-dicarboxyphenyl)ethane dianhydride, 1,1-bis(2,3-dicarboxyphenyl)ethane dianhydride, 1,2-bis(3,4-dicarboxyphenyl)ethane dianhydride, 1,1-bis(3,4-dicarboxyphenyl)ethane dianhydride, bis(3,4-dicarboxyphenyl)methane dianhydride, bis(2,3-dicarboxyphenyl)methane dianhydride, 4,4′-(p-phenylenedioxy)diphthalic dianhydride, and 4,4′-(m-phenylenedioxy)diphthalic dianhydride. Examples of the monocyclic aromatic tetracarboxylic dianhydride include 1,2,4,5-benzenetetracarboxylic dianhydride, and examples of the fused polycyclic aromatic tetracarboxylic dianhydride include 2,3,6,7-naphthalenetetracarboxylic dianhydride. These may be used singly or two or more of them may be used in combination.

Examples of the aliphatic tetracarboxylic dianhydride include cyclic or acyclic aliphatic tetracarboxylic dianhydrides. The cycloaliphatic tetracarboxylic dianhydride is a tetracarboxylic dianhydride having an alicyclic hydrocarbon structure, and examples thereof include cycloalkanetetracarboxylic dianhydrides such as 1,2,4,5-cyclohexanetetracarboxylic dianhydride, 1,2,3,4-cyclobutanetetracarboxylic dianhydride, and 1,2,3,4-cyclopentanetetracarboxylic dianhydride, bicyclo[2.2.2]oct-7-ene-2,3,5,6-tetracarboxylic dianhydride, dicyclohexyl-3,3′,4,4′-tetracarboxylic dianhydride, and regioisomers thereof. These may be used singly or two or more of them may be used in combination. Examples of the acyclic aliphatic tetracarboxylic dianhydride include 1,2,3,4-butanetetracarboxylic dianhydride and 1,2,3,4-pentanetetracarboxylic dianhydride, and these may be used singly or two or more of them may be used in combination. A cyclic aliphatic tetracarboxylic dianhydride and an acyclic aliphatic tetracarboxylic dianhydride may be used in combination.

Among the tetracarboxylic dianhydrides, 4,4′-oxydiphthalic dianhydride, 3,3′,4,4′-benzophenonetetracarboxylic dianhydride, 3,3′,4,4′-biphenyltetracarboxylic dianhydride, 2,2′,3,3′-biphenyltetracarboxylic dianhydride, 3,3′,4,4′-diphenylsulfonetracarboxylic dianhydride, 2,2-bis(3,4-dicarboxyphenyl)propane dianhydride, 4,4′-(hexafluoroisopropylidene)diphthalic dianhydride, and mixtures thereof are preferred, and 4,4′-(hexafluoroisopropylidene)diphthalic dianhydride (6FDA) is more preferred from the viewpoint of easily improving heat resistance, optical characteristics, and tensile strength.

In a preferred embodiment in the method of the present invention, the polyimide-based resin has a constitutional unit represented by Formula (1):

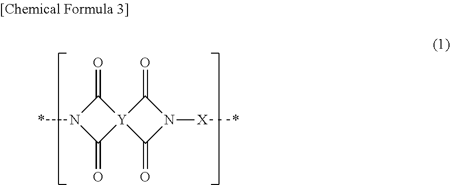

[wherein X represents a divalent organic group, Y represents a tetravalent organic group, and * represents a bonding hand], and the constitutional unit represented by Formula (1) preferably comprises a divalent aliphatic group as X. When such a polyimide-based resin is contained, the heat resistance, optical characteristics, and tensile strength of the long optical film are likely to be good.

X in Formula (1) each independently represents a divalent organic group, and preferably represents a divalent organic group having 2 to 40 carbon atoms. Examples of the divalent organic group include divalent aromatic groups and divalent aliphatic groups. In the present description, the divalent aromatic group is a divalent organic group having an aromatic group, and may contain an aliphatic group or other substituents as a part of the structure thereof. The divalent aliphatic group is a divalent organic group having an aliphatic group, and may contain other substituents as a part of the structure thereof, but does not contain any aromatic group.

X in Formula (1) comprises a divalent aliphatic group, and examples of the divalent aliphatic group include divalent acyclic aliphatic groups and divalent cyclic aliphatic groups. Among them, the divalent acyclic aliphatic groups are preferable from the viewpoint of easily achieving favorable optical characteristics, heat resistance, and tensile strength.

In one embodiment, examples of the divalent acyclic aliphatic group in X in Formula (1) include linear or branched alkylene groups such as an ethylene group, a trimethylene group, a tetramethylene group, a pentamethylene group, a hexamethylene group, a propylene group, a 1,2-butanediyl group, a 1,3-butanediyl group, a 2-methyl-1,2-propanediyl group, and a 2-methyl-1,3-propanediyl group. A hydrogen atom in the divalent acyclic aliphatic group may be substituted with a halogen atom, and a carbon atom may be replaced by a heteroatom (for example, an oxygen atom or a nitrogen atom). The number of the carbon atoms in the linear or branched alkylene group is preferably 2 or more, more preferably 3 or more, and still more preferably 4 or more, and is preferably 10 or less, more preferably 8 or less, and still more preferably 6 or less from the viewpoint of easily achieving favorable heat resistance, optical characteristics, and tensile strength. Among the divalent acyclic aliphatic groups, alkylene groups having 2 to 6 carbon atoms such as an ethylene group, a trimethylene group, a tetramethylene group, a pentamethylene group, and a hexamethylene group is preferable, and a tetramethylene group is more preferable from the viewpoint of easily achieving favorable heat resistance, optical characteristics, and tensile strength.

In one embodiment, examples of the divalent aromatic group or the divalent cyclic aliphatic group in X in Formula (1) include groups represented by Formula (10), Formula (11), Formula (12), Formula (13), Formula (14), Formula (15), Formula (16), Formula (17), and Formula (18); groups resulting from substitution of a hydrogen atom in the groups represented by Formulas (10) to (18) with a methyl group, a fluoro group, a chloro group, or a trifluoromethyl group; and chain hydrocarbon groups having 6 or less carbon atoms.

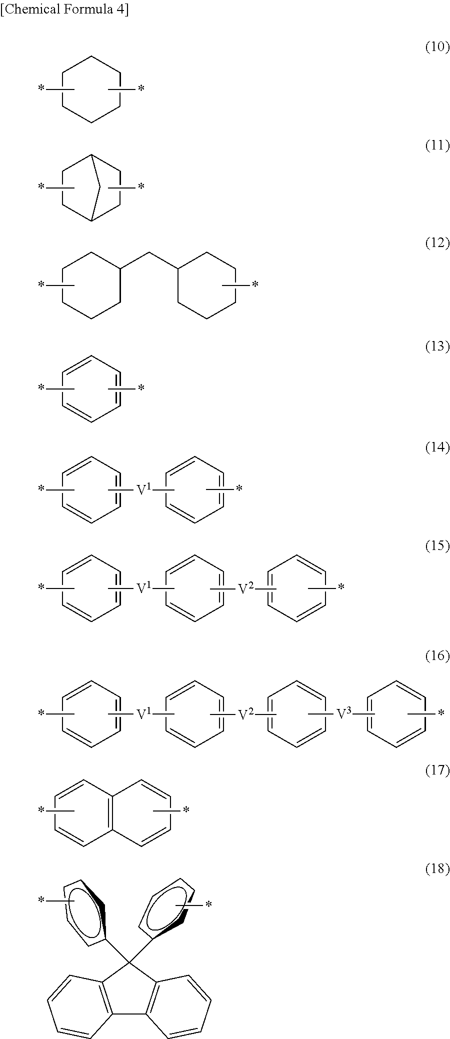

In Formulas (10) to (18),

* represents a bonding hand,

V¹, V², and V³ each independently represent a single bond, —O—, —S—, —CH₂—, —CH₂—, —CH₂—, —CH(CH₃)—, —C(CH₃)₂—, —C(CF₃)₂—, —SO₂—, —CO—, or —N(Q)-. Q represents a monovalent hydrocarbon group having 1 to 12 carbon atoms optionally substituted with a halogen atom. Examples of the monovalent hydrocarbon group having 1 to 12 carbon atoms optionally substituted with a halogen atom include a methyl group, an ethyl group, an n-propyl group, an isopropyl group, an n-butyl group, a sec-butyl group, a tert-butyl group, an n-pentyl group, a 2-methyl-butyl group, a 3-methylbutyl group, a 2-ethyl-propyl group, an n-hexyl group, an n-heptyl group, an n-octyl group, a tert-octyl group, an n-nonyl group, and an n-decyl group. Examples of the halogen atom include a fluorine atom, a chlorine atom, a bromine atom, and an iodine atom.

In one example, V and V³ are each a single bond, —O— or —S—, and V² is —CH₂—, —C(CH₃)₂—, —C(CF₃)₂— or —SO₂—. The bonding position of V and V² to each ring and the bonding position of V² and V to each ring are, independently for each other, preferably a meta position or a para position, and more preferably a para position, with respect to each ring. Hydrogen atoms on the rings in Formulas (10) to (18) may be substituted with an alkyl group having 1 to 6 carbon atoms, an alkoxy group having 1 to 6 carbon atoms, or an aryl group having 6 to 12 carbon atoms. Examples of the alkyl group having 1 to 6 carbon atoms include a methyl group, an ethyl group, an n-propyl group, an isopropyl group, an n-butyl group, a sec-butyl group, a tert-butyl group, an n-pentyl group, a 2-methyl-butyl group, a 3-methylbutyl group, a 2-ethyl-propyl group, and an n-hexyl group. Examples of the alkoxy group having 1 to 6 carbon atoms include a methoxy group, an ethoxy group, a propyloxy group, an isopropyloxy group, a butoxy group, an isobutoxy group, a tert-butoxy group, a pentyloxy group, a hexyloxy group, and a cyclohexyloxy group. Examples of the aryl group having 6 to 12 carbon atoms include a phenyl group, a tolyl group, a xylyl group, a naphthyl group, and a biphenyl group. These divalent alicyclic groups or divalent aromatic groups may be used singly or two or more of them may be used in combination.

The polyimide-based resin may contain more than one type of X, and they may be the same or different from each other. For example, a divalent acyclic aliphatic group and a divalent aromatic group and/or a divalent cyclic aliphatic group may be contained as X in Formula (1).

In one embodiment, when a divalent aliphatic group, preferably a divalent acyclic aliphatic group, is contained as X in Formula (1), the proportion of the constitutional unit in which X in Formula (1) is a divalent aliphatic group, preferably a divalent acyclic aliphatic group, is preferably 30 mol % or more, more preferably 50 mol % or more, still more preferably 70 mol % or more, and particularly preferably 90 mol % or more, and is preferably 100 mol % or less, based on the total molar amount of the constitutional unit represented by Formula (1). When the proportion of the constitutional unit in which X is a divalent aliphatic group, preferably a divalent acyclic aliphatic group in Formula (1) is within the above range, the heat resistance, optical characteristics, and tensile strength of the long optical film are easily improved. The proportion of the constitutional unit can be measured, for example, by using ¹H-NMR, or can also be calculated from the charging ratio of the raw materials.

In Formula (1), Y each independently represents a tetravalent organic group, preferably a tetravalent organic group having 4 to 40 carbon atoms, and more preferably a tetravalent organic group having 4 to 40 carbon atoms and having a cyclic structure. Examples of the cyclic structure include alicyclic, aromatic, and heterocyclic structures. The organic group is an organic group in which a hydrogen atom in the organic group is optionally substituted with a hydrocarbon group or a fluorine-substituted hydrocarbon group, and in that case, the number of the carbon atoms of the hydrocarbon group and the fluorine-substituted hydrocarbon group is preferably 1 to 8. The polyimide-based resin of the present invention may contain more than one type of Y, and they may be the same or different from each other. Examples of Y include groups represented by the following Formula (20), Formula (21), Formula (22), Formula (23), Formula (24), Formula (25), Formula (26), Formula (27), Formula (28), and Formula (29); groups resulting from substitution of a hydrogen atom in the groups represented by Formulas (20) to (29) with a methyl group, a fluoro group, a chloro group, or a trifluoromethyl group; and tetravalent chain hydrocarbon groups having 6 or less carbon atoms.

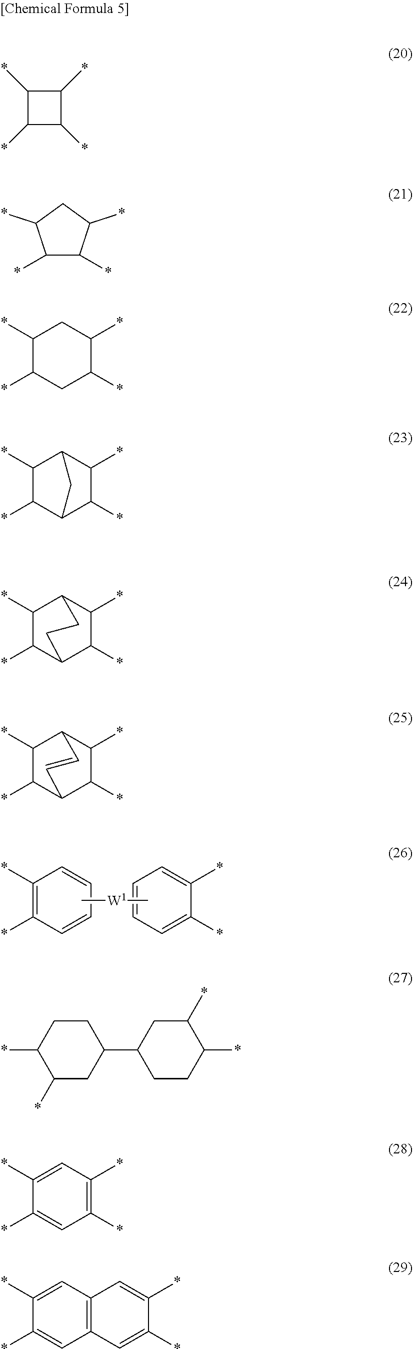

In Formulas (20) to (29),

* represents a bonding hand,

W¹ represents a single bond, —O—, —CH₂—, —CH₂—, —CH₂—, —CH(CH₃)—, —C(CH₃)₂—, —C(CF₃)₂—, —Ar—, —SO₂—, —CO—, —O—Ar—O—, —Ar—O—Ar—, —Ar—CH₂—Ar—, —Ar C(CH₃)₂—Ar, or —Ar—SO₂—Ar. Ar represents an arylene group having 6 to 20 carbon atoms in which a hydrogen atom is optionally substituted with a fluorine atom, and examples thereof include a phenylene group.

Among the groups represented by Formula (20) to Formula (29), the group represented by Formula (26), Formula (28) or Formula (29) is preferable, and the group represented by Formula (26) is more preferable from the viewpoint of easily enhancing optical characteristics and tensile strength. From the viewpoint of easily enhancing the heat resistance, optical characteristics, and tensile strength of the long optical film, W¹ is each independently preferably a single bond, —O—, —CH₂—, —CH₂—CH₂—, —CH(CH₃)—, —C(CH₃)₂—, or —C(CF₃)₂—, more preferably a single bond, —O—, —CH₂—, —CH(CH₃)—, —C(CH₃)₂—, or —C(CF₃)₂—, and still more preferably a single bond, —C(CH₃)₂—, or —C(CF₃)₂—.

In the method of the present invention, the constitutional unit represented by Formula (1) comprises, as Y, a structure represented by Formula (2)

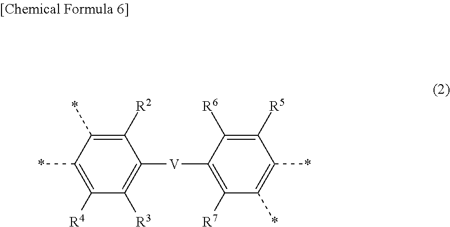

[wherein R² to R⁷ each independently represent a hydrogen atom, an alkyl group having 1 to 6 carbon atoms, an alkoxy group having 1 to 6 carbon atoms, or an aryl group having 6 to 12 carbon atoms, the hydrogen atoms contained in R² to R⁷ are each independently optionally substituted by a halogen atom, V represents a single bond, —O—, —CH₂—, —CH₂—, —CH₂—, —CH(CH₃)—, —C(CH₃)₂—, —C(CF₃)₂—, —SO₂—, —S—, —CO—, or —N(R⁸)—, R⁸ represents a hydrogen atom or a monovalent hydrocarbon group having 1 to 12 carbon atoms which is optionally substituted with a halogen atom, and * represents a bonding hand].

In such an embodiment, the long optical film is likely to exhibit superior heat resistance, optical characteristics and tensile strength. The constitutional unit represented by Formula (1) may contain one or more than one type of the structure represented by Formula (2) as Y.

In Formula (2), R², R³, R⁴, R⁵, R⁶, and R⁷ each independently represent a hydrogen atom, an alkyl group having 1 to 6 carbon atoms, an alkoxy group having 1 to 6 carbon atoms, or an aryl group having 6 to 12 carbon atoms. Examples of the alkyl group having 1 to 6 carbon atoms, the alkoxy group having 1 to 6 carbon atoms, and the aryl group having 6 to 12 carbon atoms include the alkyl groups having 1 to 6 carbon atoms, alkoxy groups having 1 to 6 carbon atoms, and aryl groups having 6 to 12 carbon atoms disclosed above as examples. R² to R⁷ each independently preferably represent a hydrogen atom or an alkyl group having 1 to 6 carbon atoms, and more preferably represent a hydrogen atom or an alkyl group having 1 to 3 carbon atoms, wherein the hydrogen atoms contained in R² to R⁷ may each independently be substituted a halogen atom. Examples of the halogen atom include a fluorine atom, a chlorine atom, a bromine atom, and an iodine atom. V represents a single bond, —O—, —CH₂—, —CH₂—CH₂—, —CH(CH₃)—, —C(CH₃)₂—, —C(CF₃)₂—, —SO₂—, —S—, —CO—, or —N(R⁸)—, and R⁸ represents a hydrogen atom or a monovalent hydrocarbon group having 1 to 12 carbon atoms which is optionally substituted with a halogen atom. Examples of the monovalent hydrocarbon group having 1 to 12 carbon atoms which is optionally substituted with a halogen atom include those disclosed above as the examples of a monovalent hydrocarbon group having 1 to 12 carbon atoms which is optionally substituted with a halogen atom. Among them, V is preferably a single bond, —O—, —CH₂—, —CH(CH₃)—, —C(CH₃)₂— or —C(CF₃)₂—, more preferably a single bond, —C(CH₃)₂— or —C(CF₃)₂—, and still more preferably a single bond or —C(CF₃)₂— from the viewpoint of easily enhancing the optical characteristics, tensile strength and flex resistance of the long optical film.

In a preferred embodiment, Formula (2) is represented by Formula (2′)

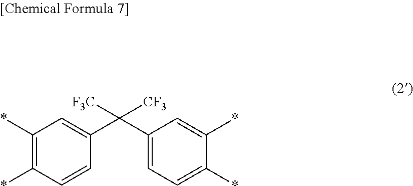 [SMILES: *c1ccc(C(c2ccc(*)c(*)c2)(C(F)(F)F)C(F)(F)F)cc1*]

[wherein * represents a bonding hand].

When Formula (2) is Formula (2′), the long optical film is more likely to exhibit superior heat resistance, optical characteristics, and tensile strength. In addition, owing to the skeleton containing a fluorine element, the solubility of the resin in a solvent can be improved, the viscosity of the varnish can be controlled low, and the processing can be facilitated.

In one embodiment, when a structure represented by Formula (2) is contained as Y in Formula (1), the proportion of the constitutional unit in which Y in Formula (1) is represented by Formula (2) is preferably 30 mol % or more, more preferably 50 mol % or more, still more preferably 70 mol % or more, and particularly preferably 90 mol % or more, and is preferably 100 mol % or less, based on the total molar amount of the constitutional unit represented by Formula (1). When the proportion of the constitutional unit in which Y in Formula (1) is represented by Formula (2) is within the above range, the heat resistance, optical characteristics, and tensile strength of the long optical film are more easily improved. The proportion of the constitutional unit in which Y in Formula (1) is represented by Formula (2) can be measured, for example, by using ¹H-NMR, or can also be calculated from the charging ratio of the raw materials.

The polyimide-based resin may contain a constitutional unit represented by Formula (30) and/or a constitutional unit represented by Formula (31) in addition to the constitutional unit represented by Formula (1).

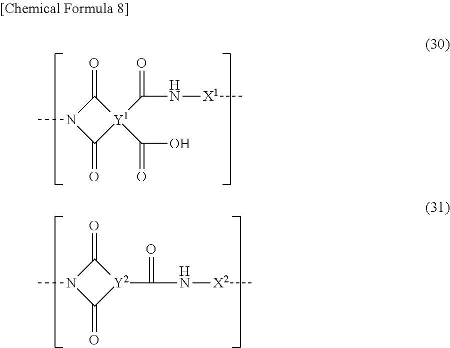

In Formula (30), Y¹ is a tetravalent organic group, and preferably an organic group in which a hydrogen atom in the organic group is optionally substituted with a hydrocarbon group or a fluorine-substituted hydrocarbon group. Examples of Y¹ include groups represented by Formula (20), Formula (21), Formula (22), Formula (23), Formula (24), Formula (25), Formula (26), Formula (27), Formula (28), and Formula (29), groups resulting from substitution of a hydrogen atom in the groups represented by Formulas (20) to (29) with a methyl group, a fluoro group, a chloro group, or a trifluoromethyl group, and tetravalent chain hydrocarbon groups having 6 or less carbon atoms. In one embodiment of the present invention, the polyimide-based resin may contain more than one type of Y¹, and they may be the same or different from each other.

In Formula (31), Y² is a trivalent organic group, and preferably an organic group in which a hydrogen atom in the organic group is optionally substituted with a hydrocarbon group or a fluorine-substituted hydrocarbon group. Examples of Y² include groups resulting from the replacement by a hydrogen atom of any one of the bonding hands of the groups represented by the above Formula (20), Formula (21), Formula (22), Formula (23), Formula (24), Formula (25), Formula (26), Formula (27), Formula (28), and Formula (29), and trivalent chain hydrocarbon groups having 6 or less carbon atoms. In one embodiment of the present invention, the polyimide-based resin may contain more than one type of Y², and they may be the same or different from each other.

In Formula (30) and Formula (31), X¹ and X² each independently represent a divalent organic group, and preferably a divalent organic group having 2 to 40 carbon atoms. Examples of the divalent organic group include a divalent aromatic group and a divalent aliphatic group, and examples of the divalent aliphatic group include a divalent acyclic aliphatic group and a divalent cyclic aliphatic group. Examples of the divalent cyclic aliphatic group or the divalent aromatic group in X¹ and X² include groups represented by of the above Formula (10), Formula (11), Formula (12), Formula (13), Formula (14), Formula (15), Formula (16), Formula (17), and Formula (18); groups resulting from substitution of a hydrogen atom in the groups represented by Formulas (10) to (18) with a methyl group, a fluoro group, a chloro group, or a trifluoromethyl group; and chain hydrocarbon groups having 6 or less carbon atoms. Examples of the divalent acyclic aliphatic group include linear or branched alkylene groups having 2 to 10 carbon atoms such as an ethylene group, a trimethylene group, a tetramethylene group, a pentamethylene group, a hexamethylene group, a propylene group, a 1,2-butanediyl group, a 1,3-butanediyl group, a 2-methyl-1,2-propanediyl group, and a 2-methyl-1,3-propanediyl group.

In one embodiment, the polyimide-based resin is composed of a constitutional unit represented by Formula (1), and optionally at least one constitutional unit selected from a constitutional unit represented by Formula (30) and a constitutional unit represented by Formula (31). In addition, from the viewpoint of easily enhancing the heat resistance, optical characteristics, and tensile strength of the long optical film, the proportion of the constitutional unit represented by Formula (1) in the polyimide-based resin is preferably 80 mol % or more, more preferably 90 mol % or more, and still more preferably 95 mol % or more, based on a total molar amount of all the constitutional units contained in the polyimide-based resin, for example, the constitutional unit represented by Formula (1), and optionally at least one constitutional unit selected from the constitutional unit represented by Formula (30) and the constitutional unit represented by Formula (31). In the polyimide-based resin, the upper limit of the proportion of the constitutional unit represented by Formula (1) is 100 mol %. The proportion mentioned above can be measured, for example, by using ¹H-NMR, or can also be calculated from the charging ratio of the raw materials. The polyimide-based resin in the present invention is preferably a polyimide resin from the viewpoint of easily enhancing the heat resistance, optical characteristics, and tensile strength of the long optical film.

In one preferred embodiment, the polyimide-based resin may contain a halogen atom, preferably a fluorine atom, which can be introduced by, for example, the above-mentioned halogen atom-containing substituent. When the polyimide-based resin contains a halogen atom, preferably a fluorine atom, heat resistance, tensile strength, and optical characteristics are easily enhanced. Examples of the fluorine-containing substituent preferable for making the polyimide-based resin contain a fluorine atom include a fluoro group and a trifluoromethyl group.

The content of the halogen atom in the polyimide-based resin is preferably 1 to 40% by mass, more preferably 5 to 40% by mass, and still more preferably 5 to 30% by mass, based on the mass of the polyimide-based resin. When the content of the halogen atom is within the above range, heat resistance, optical characteristics, and tensile strength are easily enhanced, and the polyimide-based resin is easily synthesized.

The imidization rate of the polyimide-based resin is preferably 90% or more, more preferably 93% or more, and still more preferably 95% or more. From the viewpoint of easily enhancing the optical characteristics of the long optical film, the imidization rate is preferably equal to or more than the above lower limit. The upper limit of the imidization rate is 100%. The imidization rate indicates the ratio of the molar amount of the imide linkage in the polyimide-based resin to a value twice the molar amount of the constitutional unit derived from the tetracarboxylic acid compound in the polyimide-based resin. When the polyimide-based resin contains a tricarboxylic acid compound, the imidization rate indicates the ratio of the molar amount of the imide linkage in the polyimide-based resin to the sum total of a value twice the molar amount of the constitutional unit derived from the tetracarboxylic acid compound and the molar amount of the constitutional unit derived from the tricarboxylic acid compound in the polyimide-based resin. The imidization rate can be determined by an IR method, an NMR method, or the like.

In one embodiment, the content of the polyimide-based resin contained in the long optical film is preferably 40% by mass or more, more preferably 50% by mass or more, still more preferably 60% by mass or more, and particularly preferably 80% by mass or more, and is preferably 100% by mass or less based on the mass (100% by mass) of the long optical film. When the content of the polyimide-based resin contained in the long optical film is within the above range, the heat resistance, optical characteristics, and tensile strength of the resulting long optical film are easily enhanced.

### <Method for Producing Polyimide-Based Resin>

In the present invention, the polyimide-based resin to be used may be a commercially available product or may be produced by a conventional method. The method for producing the polyimide-based resin is not particularly limited, but in one embodiment, the polyimide-based resin comprising the constitutional unit represented by Formula (1) can be produced by a method comprising a step of reacting a diamine compound with a tetracarboxylic acid compound to obtain a polyamic acid, and a step of imidizing the polyamic acid. In addition to the tetracarboxylic acid compound, a tricarboxylic acid compound may be reacted.

As the tetracarboxylic acid compound to be used for the synthesis of the polyimide-based resin, for example, the same compounds as the tetracarboxylic acid compound, the diamine compound, and the tricarboxylic acid compound described in the section of [Polyimide-based resin] can be used.

In the production of the polyimide-based resin, the amounts of the diamine compound, the tetracarboxylic acid compound, and the tricarboxylic acid compound used can be appropriately chosen according to the ratio of each constitutional unit of the desired resin.

In a preferred embodiment, the amount of the diamine compound used is preferably 0.95 mol or more, more preferably 0.98 mol or more, still more preferably 0.99 mol or more, and particularly preferably 0.995 mol or more, and is preferably 1.05 mol or less, more preferably 1.02 mol or less, still more preferably 1.01 mol or less, and particularly preferably 1.005 mol or less, with respect to 1 mol of the tetracarboxylic acid compound. When the amount of the diamine compound used with respect to the tetracarboxylic acid compound is within the above range, the heat resistance, optical characteristics, and tensile strength of the resulting long optical film are easily enhanced.

The reaction temperature of the diamine compound and the tetracarboxylic acid compound is not particularly limited, and may be, for example, 40 to 180° C., and the reaction time is not particularly limited, and may be, for example, about 0.5 to 12 hours. In a preferred embodiment, the reaction temperature is preferably 50 to 160° C. and the reaction time is preferably 0.5 to 10 hours. With such a reaction temperature and reaction time, it is easy to enhance the optical characteristics of the long optical film.

The reaction between the diamine compound and the tetracarboxylic acid compound is preferably performed in a solvent. The solvent is not particularly limited as long as it does not affect the reaction, and examples thereof include alcohol-based solvents such as water, methanol, ethanol, ethylene glycol, isopropyl alcohol, propylene glycol, ethylene glycol methyl ether, ethylene glycol butyl ether, 1-methoxy-2-propanol, 2-butoxyethanol, and propylene glycol monomethyl ether; ester-based solvents such as ethyl acetate, butyl acetate, ethylene glycol methyl ether acetate, γ-butyrolactone, γ-valerolactone, propylene glycol methyl ether acetate, and ethyl lactate; ketone-based solvents such as acetone, methyl ethyl ketone, cyclopentanone, cyclohexanone, 2-heptanone, and methyl isobutyl ketone; aliphatic hydrocarbon solvents such as pentane, hexane, and heptane; alicyclic hydrocarbon solvents such as ethylcyclohexane; aromatic hydrocarbon solvents such as toluene and xylene; phenol-based solvents such as phenol and cresol; nitrile-based solvents such as acetonitrile; ether-based solvents such as tetrahydrofuran and dimethoxyethane; chlorine-containing solvents such as chloroform and chlorobenzene; amide-based solvents such as N,N-dimethylacetamide and N, N-dimethylformamide; sulfur containing solvents such as dimethyl sulfone, dimethyl sulfoxide, and sulfolane; carbonate-based solvents such as ethylene carbonate and propylene carbonate; and combinations thereof. Among them, phenol-based solvents and amide-based solvents can be suitably used from the viewpoint of solubility.

In a preferred embodiment, the solvent to be used in the reaction is preferably a solvent strictly dehydrated to a water content of 700 ppm or less. When such a solvent is used, the optical characteristics and tensile strength of the long optical film are easily enhanced.

The reaction between the diamine compound and the tetracarboxylic acid compound may be carried out under an inert atmosphere (nitrogen atmosphere, argon atmosphere, etc.) or under reduced pressure, as necessary, and is preferably carried out under an inert atmosphere (nitrogen atmosphere, argon atmosphere, etc.) while stirring in a strictly controlled dehydrated solvent. Under such conditions, the optical characteristics and tensile strength of the resulting long optical film are easily enhanced.

In the imidization step, imidization may be carried out using an imidization catalyst, imidization may be carried out by heating, or a combination thereof may be employed. Examples of the imidization catalyst to be used in the imidization step include aliphatic amines such as tripropylamine, dibutylpropylamine, and ethyldibutylamine; alicyclic amines (monocyclic) such as N-ethylpiperidine, N-propylpiperidine, N-butylpyrrolidine, N-butylpiperidine, and N-propylhexahydroazepine; alicyclic amines (polycyclic) such as azabicyclo[2.2.1]heptane, azabicyclo[3.2.1]octane, azabicyclo[2.2.2]octane, and azabicyclo[3.2.2]nonane; and aromatic amines such as pyridine, 2-methylpyridine (2-picoline), 3-methylpyridine (3-picoline), 4-methylpyridine (4-picoline), 2-ethylpyridine, 3-ethylpyridine, 4-ethylpyridine, 2,4-dimethylpyridine, 2,4,6-trimethylpyridine, 3,4-cyclopentenopyridine, 5,6,7,8-tetrahydroisoquinoline, and isoquinoline. From the viewpoint of easily accelerating the imidization reaction, it is preferable to use an acid anhydride together with the imidization catalyst. Examples of the acid anhydride include common acid anhydrides used for imidization reactions, and examples thereof include aliphatic acid anhydrides such as acetic anhydride, propionic anhydride, and butyric anhydride, and anhydrides of aromatic acids such as phthalic acid.

In one embodiment, in the case of carrying out imidization, the reaction temperature is preferably 40° C. or higher, more preferably 60° C. or higher, and still more preferably 80° C. or higher, and is preferably 190° C. or lower, more preferably 170° C. or lower, and still more preferably 150° C. or lower. The reaction time of the imidization step is preferably 30 minutes to 24 hours, and more preferably 1 to 12 hours.

The polyimide-based resin may be isolated (separated and purified) by a conventional method, for example, a separation means such as filtration, concentration, extraction, crystallization, recrystallization, or column chromatography, or a separation means combining these. In a preferred embodiment, the polyimide-based resin can be isolated by adding a large amount of an alcohol such as methanol to a reaction solution containing the resin to precipitate the resin, and then performing concentration, filtration, drying, or the like.

### [Long Optical Film]

The long optical film produced by the method of the present invention has high smoothness and good appearance. Therefore, the long optical film produced by the method of the present invention can be suitably used for various applications with being cut into a desired size.

In the present invention, the long optical film refers to an optical film having a width of usually 50 cm or more, more preferably 80 cm or more, still more preferably 100 cm or more, particularly preferably 120 cm or more, and a length of preferably 5 times or more, more preferably 10 times or more the width. Such a long optical film is preferably wound in a roll shape as a film roll. When the width of the film is less than the lower limit value, it is difficult to adapt the film to a so-called roll-to-roll method, and there is a possibility that mass production is impossible. The upper limit value of the width of the long optical film is preferably 200 cm, more preferably 180 cm or less, and still more preferably 160 cm or less. When the width of the film exceeds the above-mentioned upper limit value, there is a possibility that excessively large production equipment is required. The width of the long optical film can be adjusted to within the above range, for example, by applying a varnish to a substrate such that the resulting coating film has a desired width in the application step.

The glass transition temperature Tg of the long optical film produced by the method of the present invention is preferably 170° C. or higher, more preferably 175° C. or higher, still more preferably 180° C. or higher, particularly preferably higher than 180° C., especially preferably 180.5° C. or higher, and most preferably 181° C. or higher. When the glass transition temperature Tg is equal to or higher than the lower limit value, tensile strength and heat resistance tend to be superior. The glass transition temperature Tg is preferably 400° C. or lower, more preferably 380° C. or lower, still more preferably 350° C. or lower, and particularly preferably 300° C. or lower. The glass transition temperature Tg can be controlled to within the above range, for example, by appropriately adjusting the type and constitution ratio of the constitutional units constituting the resin contained in the long optical film; the thickness of the long optical film; the solvent content of the long optical film; the type of additives; the production conditions of the resin and the purity of monomers; and the production conditions of the long optical film. In particular, the glass transition temperature Tg may be adjusted to within the above range by employing those described above as a preferable type and constitution ratio of the constitutional units constituting the resin, adjusting the solvent content of the long optical film, applying the drying conditions in the above-described long optical film production process, and the like. The glass transition temperature Tg in the present invention is a glass transition temperature by DSC (differential scanning calorimetry). The glass transition temperature Tg can be measured by, for example, the method described in EXAMPLES described later.

The optical transmittance at 350 nm of the long optical film produced by the method of the present invention is preferably 10% or less, more preferably 9% or less, still more preferably 8% or less, particularly preferably 6% or less, and most preferably 5% or less. When the optical transmittance at 350 nm is equal to or less than the above upper limit, the UV-blocking property can be improved. The lower limit of the optical transmittance at 350 nm is 0%. The optical transmittance at 350 nm is preferably an optical transmittance in the range of the thickness (film thickness) of the long optical film of the present invention. The optical transmittance at 350 nm can be adjusted to within the above range, for example, by appropriately adjusting the type and constitution ratio of the constitutional units constituting the resin contained in the long optical film; the thickness of the long optical film; the solvent content of the optical film; the type of additives; the production conditions of the resin and the purity of monomers; and the production conditions of the long optical film. For example, the optical transmittance at 350 nm can be easily adjusted to within the above range by appropriately adjusting the type and amount of ultraviolet absorbers contained in the long optical film.

The optical transmittance at 500 nm of the long optical film produced by the method of the present invention is preferably 90.0% or more, more preferably 90.2% or more, and still more preferably 90.4% or more. Therefore, in a preferred embodiment, the film can achieve both the blocking property in the ultraviolet region and the transmittance in the visible region. When the optical transmittance at 500 nm is equal to or more than the above lower limit value, it is easy to enhance the visibility when applied to a display device or the like. The upper limit of the optical transmittance at 500 nm is 100%. The optical transmittance at 500 nm is preferably an optical transmittance in the range of the thickness (film thickness) of the long optical film of the present invention, and is particularly an optical transmittance when the thickness of the long optical film is preferably 22 to 40 μm, more preferably 23 to 27 μm, and still more preferably 25 μm. The optical transmittance at 500 nm can be adjusted to within the above range by appropriately adjusting the type and constitution ratio of the constitutional units constituting the resin contained in the long optical film; the thickness of the long optical film, the solvent content of the long optical film; the type of additives; the production conditions of the resin and the purity of monomers; and the production conditions of the long optical film. In particular, the optical transmittance at 500 nm may be adjusted to within the above range, for example, by employing the above-described preferable type and constitution ratio of the constitutional units constituting the resin, adjusting the solvent content of the long optical film, and applying the drying conditions in the above-described long optical film production process. The optical transmittance at 350 nm or 500 nm can be measured by, for example, the method described in EXAMPLES described later.

The tensile strength of the long optical film produced by the method of the present invention is preferably 70 MPa or more, more preferably 80 MPa or more, still more preferably 85 MPa or more, particularly preferably more than 86 MPa, especially preferably 87 MPa or more, and further preferably 89 MPa or more, and is preferably 200 MPa or less, and more preferably 180 MPa or less. When the tensile strength is within the above range, breakage or the like of the film is easily suppressed, and the flexibility is easily enhanced. The tensile strength can be adjusted to within the above range by appropriately adjusting the type or constitution ratio of the constitutional units constituting the resin contained in the optical film; the solvent content of the long optical film; the type and blending amount of additive; the production conditions of the resin and the purity of monomers; and the production conditions of the long optical film. In particular, the tensile strength may be adjusted to within the above range, for example, by employing the above-described preferable type and constitution ratio of the constitutional units constituting the resin, adjusting the solvent content of the long optical film, and applying the drying conditions in the above-described long optical film production process. The tensile strength can be measured, for example, by the method described in EXAMPLES described later.

The maximum height roughness Rz defined by JIS B-0601: 2013 of at least one surface of the long optical film produced by the method of the present invention is 2.0 μm or less, preferably 1.8 μm or less, and more preferably 1.5 μm or less. The lower limit value of the maximum height roughness Rz is usually 0 μm. When the maximum height roughness Rz is within the above range, there are not many irregularities on the film surface and the appearance of the film is likely to be good. The maximum height roughness Rz can be adjusted to within the above range by, for example, the type of the solvent or the drying conditions in the varnish preparation step. The maximum height roughness Rz can be measured, for example, by the method described in EXAMPLES described later. Therefore, the present invention also relates to a long optical film comprising a polyimide-based resin, wherein the polyimide-based resin comprises a constitutional unit derived from an aliphatic diamine, and the long optical film has a maximum height roughness Rz defined by JIS B-0601: 2013 of 2.0 μm or less on at least one surface thereof.

In one preferred embodiment, the long optical film produced by the method of the present invention has a maximum height roughness Rz defined by JIS B-0601: 2013 of 2.0 μm or less, preferably 1.8 μm or less, and more preferably 1.5 μm or less on a surface which has not been in contact with the substrate. Therefore, the present invention also relates to a long optical film comprising a polyimide-based resin, wherein the polyimide-based resin comprises a constitutional unit derived from an aliphatic diamine, and the long optical film has a maximum height roughness Rz defined by JIS B-0601: 2013 of 2.0 μm or less on a surface which has not been in contact with the substrate. In a further preferable embodiment, the long optical film produced by the method of the present invention preferably has a maximum height roughness Rz of 2.0 μm or less on both the surface which has been in contact with the substrate and the surface which has not been in contact with the substrate.

The thickness retardation (retardation in the thickness direction) Rth of the long optical film produced by the method of the present invention is preferably 100 nm or less, more preferably 90 nm or less, and still more preferably 85 nm or less, and is preferably 1 nm or more, and more preferably 5 nm or more. When the thickness retardation Rth is within the above range, visibility is easily improved when the film is applied to a display device or the like. The thickness retardation Rth can be adjusted to within the above ranges, for example, by appropriately adjusting the type or constitution ratio of the constitutional units constituting the resin contained in the long optical film; the thickness of the long optical film; the solvent content of the long optical film; the type and blending amount of additive; the production conditions of the resin and the purity of monomers; and the production conditions of the long optical film, and in particular, the thickness retardation Rth is easily adjusted to within the above ranges by making the resin contained in the optical film to contain a constitutional unit having an acyclic aliphatic skeleton as a constitutional unit constituting the resin. The thickness retardation Rth can be measured with, for example, a retardation measuring device.

The long optical film produced by the method of the present invention has a solvent content (also referred to as a residual solvent amount) of preferably 3.0% by mass or less, more preferably 2.5% by mass or less, still more preferably 2.0% by mass or less, and preferably 0.01% by mass or more, more preferably 0.1% by mass or more, and still more preferably 0.5% by mass or more, based on the mass of the long optical film. When the solvent content is equal to or less than the above upper limit, heat resistance and tensile strength are easily enhanced. When the solvent content is equal to or more than the above lower limit, optical characteristics are easily improved, for example, the optical transmittance at 500 nm is easily increased and the optical transmittance at 350 nm is easily reduced. The solvent content (residual solvent amount) corresponds to a mass loss ratio S (% by mass) from 120° C. to 250° C. determined using a TG-DTA measuring apparatus. The mass loss ratio S is determined by, for example, raising the temperature of about 20 mg of an optical film from room temperature to 120° C. at a temperature raising rate of 10° C./min, holding the optical film at 120° C. for 5 minutes, then performing TG-DTA measurement while raising the temperature (heating) to 400° C. at a temperature raising rate of 10° C./min, and calculating the mass loss ratio S based on a TG-DTA measurement result according to Equation (1):

mass loss ratio S(% by mass)=100−(W1/W0)×100 (1)

[wherein W0 is a mass of the sample after holding at 120° C. for 5 minutes, and W1 is a mass of the sample at 250° C.], and the mass loss ratio S can be measured and calculated by, for example, the method described in EXAMPLES. The solvent content may be adjusted to within the above range by appropriately adjusting drying conditions (particularly, drying temperature, drying time, and the like) in the long optical film production process described above, for example. For example, the solvent content tends to decrease as the drying temperature increases. In addition, the lower the solvent content, the higher the Tg tends to be.

The thickness of the long optical film produced by the method of the present invention may be appropriately chosen according to the application, and is preferably 5 μm or more, more preferably 10 μm or more, and still more preferably 15 μm or more, and is preferably 100 μm or less, more preferably 80 μm or less, still more preferably 60 μm or less, and particularly preferably 50 μm or less. The thickness of the long optical film can be adjusted to within the above range, for example, by appropriately adjusting the thickness of a coating film in the application step in the above-described production method. The thickness of the long optical film can be measured using, for example, a film thickness meter or the like.

### <Additives>

In the present invention, the long optical film may further contain an ultraviolet absorber. Examples of the ultraviolet absorber include benzotriazole derivatives (benzotriazole-based ultraviolet absorbers), triazine derivatives (triazine-based ultraviolet absorbers) such as 1,3,5-triphenyltriazine derivatives, benzophenone derivatives (benzophenone-based ultraviolet absorbers), and salicylate derivatives (salicylate-based ultraviolet absorbers), and at least one selected from the group consisting of these can be used. From the viewpoint of exhibiting ultraviolet absorbability in the vicinity of 300 to 400 nm, preferably 320 to 360 nm, and being capable of improving the UV-blocking property of the long optical film, it is preferable to use at least one selected from the group consisting of benzotriazole-based ultraviolet absorbers and triazine-based ultraviolet absorbers, and benzotriazole-based ultraviolet absorbers are more preferable.

Examples of the benzotriazole-based ultraviolet absorber include a compound represented by Formula (I), trade name: Sumisorb (registered trademark) 250 (2-[2-hydroxy-3-(3,4,5,6-tetrahydrophthalimide-methodiyl)-5-methylphenyl]benzotriazole) manufactured by Sumitomo Chemical Co., Ltd., trade name: Tinuvin (registered trademark) 360 (2,2′-methylenebis[6-(2H-benzotriazol-2-yl)-4-tert-octylphenol]) and Tinuvin 213 (a reaction product of methyl 3-[3-(2H-benzotriazol-2-yl)-5-tert-butyl-4-hydroxyphenyl]propionate with PEG 300) manufactured by BASF Japan Ltd. These may be used singly or two or more of them may be used in combination. Examples of the compound represented by Formula (I) include trade name: Sumisorb 200 (2-(2-hydroxy-5-methylphenyl)benzotriazole), Sumisorb 300 (2-(3-tert-butyl-2-hydroxy-5-methylphenyl)-5-chlorobenzotriazole), Sumisorb 340 (2-(2-hydroxy-5-tert-octylphenyl)benzotriazole), and Sumisorb 350 (2-(2-hydroxy-3,5-di-tert-pentylphenyl)benzotriazole) manufactured by Sumitomo Chemical Co., Ltd., trade name: Tinuvin 327 (2-(2′-hydroxy-3′,5′-di-tert-butylphenyl) chlorobenzotriazole), Tinuvin 571 (2-(2H-benzotriazo-2-yl)-6-dodecyl methyl-phenol), and Tinuvin 234 (2-(2H-benzotriazol-2-yl)-4,6-bis(1-methyl-1-phenylethyl)phenol) manufactured by BASF Japan Ltd., and trade name: ADK STAB (registered trademark) LA-31 (2,2′-methylenebis[6-(2H-benzotriazol-2-yl)-4-(1,1,3,3-tetramethylbutyl)phenol]) manufactured by ADEKA Corporation. The ultraviolet absorber is preferably a compound represented by Formula (I) and Tinuvin 213 (a reaction product of methyl 3-[3-(2H-benzotriazol-2-yl)-5-tert-butyl-4-hydroxyphenyl]propionate and PEG 300, more preferably, trade names: Sumisorb 200 (2-(2-hydroxy-5-methylphenyl)benzotriazole), Sumisorb 300 (2-(3-tert-butyl-2-hydroxy-5-methylphenyl)-5-chlorobenzotriazole), Sumisorb 340 (2-(2-hydroxy-5-tert-octylphenyl)benzotriazole), Sumisorb 350 (2-(2-hydroxy-3,5-di-tert-pentylphenyl)benzotriazole) manufactured by Sumitomo Chemical Co., Ltd., product name: ADK STAB LA-31 (2,2′-methylenebis[6-(2H-benzotriazol-2-yl)-4-(1,1,3,3-tetramethylbutyl)phenol]) manufactured by ADEKA Corporation, and trade names: Tinuvin 327 (2-(2′-hydroxy-3′,5′-di-tert-butylphenyl)-5-chlorobenzotriazole) and Tinuvin 571 (2-(2H-benzotriazo-2-yl)-6-dodecyl-4-methyl-phenol) manufactured by BASF Japan Ltd., and most preferably trade name: Sumisorb 340 (2-(2-hydroxy-5-tert-octylphenyl)benzotriazole) and Sumisorb 350 (2-(2-hydroxy-3,5-di-tert-pentylphenyl)benzotriazole) manufactured by Sumitomo Chemical Co., Ltd., and product name: ADK STAB LA-31 (2,2′-methylenebis[6-(2H-benzotriazol-2-yl)-4-(1,1,3,3-tetramethylbutyl)phenol]) manufactured by ADEKA Corporation.

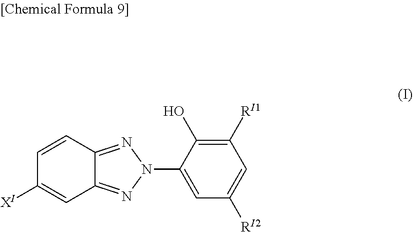

In Formula (I), X¹ is a hydrogen atom, a fluorine atom, a chlorine atom, an alkyl group having 1 to 5 carbon atoms, or an alkoxy group having 1 to 5 carbon atoms, R¹¹ and R¹² are each independently a hydrogen atom or a hydrocarbon group having 1 to 20 carbon atoms, and at least one of R¹¹ and R¹² is a hydrocarbon group having 1 to 20 carbon atoms.

Examples of the alkyl group having 1 to 5 carbon atoms in X¹ include a methyl group, an ethyl group, an n-propyl group, an isopropyl group, an n-butyl group, a sec-butyl group, a tert-butyl group, an n-pentyl group, a 2-methyl-butyl group, a 3-methylbutyl group, and a 2-ethyl-propyl group.

Examples of the alkoxy group having 1 to 5 carbon atoms in X¹ include a methoxy group, an ethoxy group, an n-propoxy group, an isopropoxy group, an n-butoxy group, a sec-butoxy group, a tert-butoxy group, a n-pentyloxy group, a 2-methyl-butoxy group, a 3-methylbutoxy group, and a 2-ethyl-propoxy group.

X¹ is preferably a hydrogen atom, a fluorine atom, a chlorine atom, or a methyl group, and more preferably a hydrogen atom, a fluorine atom, or a chlorine atom.

R¹¹ and R¹² are each independently a hydrogen atom or a hydrocarbon group having 1 to 20 carbon atoms, and at least one of R¹¹ and R¹² is a hydrocarbon group. When R¹¹ and R¹² are each a hydrocarbon group, they are preferably a hydrocarbon group having 1 to 12 carbon atoms, and more preferably a hydrocarbon group having 1 to 8 carbon atoms. Specific examples thereof include a methyl group, a tert-butyl group, a tert-pentyl group, and a tert-octyl group.

As the ultraviolet absorber according to another preferred embodiment, a triazine-based ultraviolet absorber is used in a long optical film containing a polyimide-based resin. Examples of the triazine-based ultraviolet absorber include a compound represented by the following Formula (II). Examples thereof include product name: ADK STAB LA-46 (2-(4,6-diphenyl-1,3,5-triazin-2-yl)-5-[2-(2-ethylhexanoyloxy)ethoxy]phenol) of ADEKA Corporation, trade name: Tinuvin 400 (2-[4-[2-hydroxy-3-tridecyloxypropyl]oxy]-2-hydroxyphenyl]-4,6-bis(2,4-dimethylphenyl)-1,3,5-triazine), 2-[4-[2-hydroxy-3-didecyloxypropyl]oxy]-2-hydroxyphenyl]-4,6-bis(2,4-dimethylphenyl)-1,3,5-triazine), Tinuvin 405 (2-[4(2-hydroxy-3-(2′-ethyl)hexyl)oxy]-2-hydroxyphenyl]-4,6-bis(2,4-dimethylphenyl)-1,3,5-triazine), Tinuvin 460 (2,4-bis(2-hydroxy-4-butyloxyphenyl)-6-(2,4-bis-butyloxyphenyl)-1,3,5-triazine), and Tinuvin 479 (hydroxyphenyltriazine-based ultraviolet absorbent) manufactured by BASF Japan Ltd., and product name: KEMISORB (registered trademark) 102 (2-[4,6-bis(2,4-dimethylphenyl)-1,3,5-triazin-2-yl]-5-(n-octyloxy)phenol) of Chemipro Kasei Kaisha, Ltd. These can be used singly or two or more of them may be used in combination. The compound represented by Formula (II) is preferably ADK STAB LA-46 (2-(4,6-diphenyl-1,3,5-triazin-2-yl)-5-[2-(2-ethylhexanoyloxy)ethoxy]phenol).

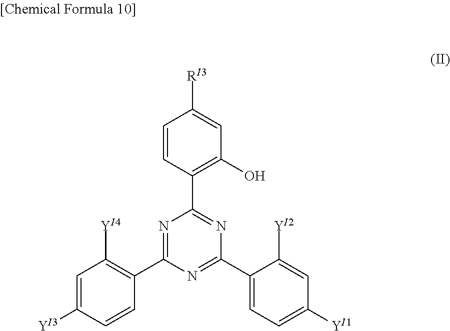

In Formula (II), Y¹¹ to Y¹⁴ each independently represent a hydrogen atom, a fluorine atom, a chlorine atom, a hydroxy group, an alkyl group having 1 to 20 carbon atoms, or an alkoxy group having 1 to 20 carbon atoms, preferably a hydrogen atom, an alkyl group having 1 to 12 carbon atoms, or an alkoxy group having 1 to 12 carbon atoms, and more preferably a hydrogen atom.

In Formula (II), R¹³ is a hydrogen atom, a hydrocarbon group having 1 to 20 carbon atoms, an alkoxy group having 1 to 20 carbon atoms containing one oxygen atom, or an alkoxy group having 1 to 4 carbon atoms substituted with an alkylketoxy group having 1 to 12 carbon atoms, preferably an alkoxy group having 1 to 12 carbon atoms containing one oxygen atom or an alkoxy group having 2 to 4 carbon atoms substituted with an alkylketoxy group having 8 to 12 carbon atoms, and more preferably an alkoxy group having 2 to 4 carbon atoms substituted with an alkylketoxy group having 8 to 12 carbon atoms.

Examples of the alkyl group having 1 to 20 carbon atoms as Y¹¹ to Y¹⁴ include a methyl group, an ethyl group, an n-propyl group, an isopropyl group, an n-butyl group, a sec-butyl group, a tert-butyl group, an n-pentyl group, an n-hexyl group, an n-heptyl group, an n-octyl group, an n-nonyl group, an n-decyl group, an n-dodecyl group, and an n-undecyl group.

The ultraviolet absorber preferably has light absorption of 300 to 400 nm, more preferably has light absorption of 330 to 390 nm, and still more preferably has light absorption around 350 nm.

In the present invention, when the long optical film contains an ultraviolet absorber, the content of the ultraviolet absorber is preferably 0.01 parts by mass or more, more preferably 0.1 parts by mass or more, still more preferably 0.5 parts by mass or more, and particularly preferably 1 part by mass or more, and is preferably 10 parts by mass or less, more preferably 8 parts by mass or less, and still more preferably 5 parts by mass or less, based on 100 parts by mass of the polyimide-based resin. When the content of the ultraviolet absorber is within the above range, the UV-blocking property of the long optical film is easily improved, and the transparency and the tensile strength are easily enhanced.

The long optical film produced by the method of the present invention may further contain additives other than the ultraviolet absorber. Examples of other additives include antioxidants, mold release agents, stabilizers, brewing agents, flame retardants, pH regulators, silica dispersants, lubricants, thickeners, and leveling agents. When other additives are contained, the content thereof may be preferably 0.001 to 20% by mass, more preferably 0.01 to 15% by mass, and still more preferably 0.1 to 10% by mass based on the mass of the long optical film. In addition, the long optical film may further contain a filler or the like. The content thereof is preferably 1% by mass to 30% by mass.

In the step of preparing a varnish by dissolving a polyimide-based resin in a solvent, such an additive may be mixed in advance in the solvent before dissolving the polyimide-based resin, or may be added later to the varnish dissolving the polyimide-based resin and mixed

The application of the long optical film produced by the method of the present invention is not particularly limited, and the long optical film may be used for various applications, for example, a substrate for a touch sensor, a material for a flexible display device, a protective film, a film for bezel printing, a semiconductor application, a speaker diaphragm, and an IR cut filter.

### EXAMPLES

Hereinafter, the present invention will be described more specifically based on Examples and Comparative Examples, but the present invention is not limited to the following Examples. First, methods of measurement and evaluation will be described.

### <Moisture Absorption Speed Per Unit Area of Solvent>

A solvent (40 mL) was put in a plastic container with a volume of 100 mL (bottom diameter: 45 mm, opening diameter: 50 mm) and held for 30 minutes or 60 minutes in an environment with a temperature of 22.0° C. and a relative humidity of 30% RH. After holding for a prescribed time, the entire solvent was stirred with a spatula for 1 to 2 seconds, and the stirred solvent was transferred to a glass bottle having a volume of 10 mL to fill the glass bottle, and the glass bottle was sealed to afford a solvent sample. Under the same atmosphere as described above, a moisture absorption speed per one hour (% by mass/h) and a moisture absorption speed per one minute Vs (% by mass/min) were determined from water amounts at 30 minutes and 60 minutes determined by a volumetric titration method using a vaporizable Karl Fischer moisture titrator (“831”, “832” (manufactured by Metrohm Corporation)). The value obtained by dividing the moisture absorption speed per hour by the unit area of the opening of the plastic container was defined as the moisture absorption speed per unit area.

### <Glass Transition Temperature Tg>

The glass transition temperature Tg was measured using DSC Q200 manufactured by TA Instruments under the conditions of a measurement sample amount: 5 mg, a temperature range: from room temperature to 400° C., and a temperature raising rate: 10° C./min.

### <Optical Transmittance>

As the optical transmittance, the transmittance with respect to light of 200 to 800 nm was measured using a UV-Visible/NIR spectrophotometer V-670 manufactured by JASCO Corporation.

### <Tensile Strength>

The tensile strength was measured using Autograph AG-IS manufactured by Shimadzu Corporation. A strip-shaped optical film substrate having a width of 10 mm and a length of 100 mm was prepared as a test piece from a long optical film. A tensile test was carried out under the conditions of a chuck distance of 50 mm and a tensile speed of 20 mm/min, and the tensile strength was measured.

### <Thickness Retardation Rth>

The thickness retardation Rth was measured using a retardation measuring device (trade name: KOBRA) manufactured by Oji Scientific Instruments Co., Ltd. Specifically, the thickness retardation Rth is calculated by the following equation, where the refractive index in one direction in the film plane is Nx, the refractive index in a direction orthogonal to Nx is Ny, the refractive index in the thickness direction of the film is Nz, and the thickness of the film is d (nm). Nx is a refractive index in the slow axis direction, Ny is a refractive index in the fast axis direction, and these satisfy Nx>Ny.

Rth={(Nx+Ny)/2−Nz}×d(nm)

### <Solvent Content>

### (Thermogravimetry-Differential Thermal Analysis (TG-DTA) Measurement)

The residual solvent amount of each of the long optical films obtained in Examples and Comparative Examples was measured using a TG-DTA measuring apparatus (“TG/DTA 6300”, manufactured by Hitachi High-Tech Science Corporation).

About 20 mg of sample was obtained from the optical film. The sample was heated from room temperature to 120° C. at a temperature raising rate of 10° C./min and held at 120° C. for 5 minutes, and then the mass change of the sample was measured while raising the temperature (heating) to 400° C. at a temperature raising rate of 10° C./min.

From the results of TG-DTA measurement, the mass loss ratio S (% by mass) from 120° C. to 250° C. was calculated according to the following Equation (1).

S(% by mass)=100−(W1/W0)×100 (1)

[In Equation (1), W0 is the mass of the sample after holding at 120° C. for 5 minutes, and W1 is the mass of the sample at 250° C.].

The mass loss ratio S calculated was defined as a residual solvent amount S (% by mass) in the long optical film.

### <Thickness>

The thickness of the long optical film was measured at n=3 using a contact type digital thickness meter (manufactured by Mitutoyo Corporation).

### <Viscosity>

The viscosity of a varnish was measured using an E-type viscometer (“HBDV-II+P CP” manufactured by Brookfield) was used. Using 0.6 cc of the varnish as a sample, the viscosity was measured under the conditions of 25° C. and a rotation speed of 3 rpm.

### <Maximum Height Roughness Rz>

A laser displacement meter CL-3050 and a sensor head CL-PT010 manufactured by KEYENCE CORPORATION were used. The measurement was carried out by randomly scanning the front and back surfaces of a 10 cm×10 cm optical film with a measurement width of 1 cm. Five points were measured for each surface (10 times in total), and the average value of the measurements was defined as Rz.

### <Appearance Evaluation>

The appearance such as the surface irregularities of a long optical film was observed under a fluorescent lamp and judged according to the following criteria.

### (Evaluation Criteria)

∘ . . . No appearance abnormality such as surface irregularities is observed.
Δ . . . Appearance abnormality such as surface irregularities is slightly observed.
x . . . An appearance abnormality such as surface irregularities is clearly observed.

### Synthesis Example 1: Preparation of Polyimide-Based Resin

A polyimide-based resin (6FDA-DAB) composed of a constitutional unit derived from 6FDA and a constitutional unit derived from 1,4-DAB was produced by the method described in WO 2019/156717 A.

### [Production of Long Optical Film]

### Example 1

The polyimide obtained in Synthesis Example 1 was dissolved in cyclohexanone (CH: moisture absorption speed per unit area: 19% by mass/h·m²) such that the solid content concentration was 12% by mass. 2 phr of Sumisorb 340 was added as a UVA to prepare a polyimide-based varnish (varnish viscosity: 26 Pa s). Next, the polyimide-based varnish was applied in a width of 50 cm and a length of 10 m to a PET roll substrate using a coater facility installed in a thermostatic chamber (temperature: 22° C., humidity: 50% RH), the PET substrate was conveyed into a drying furnace of the coater facility, and the coating film was heated at 30° C. for 2 minutes and then at 140° C. for 8 minutes. Thereafter, the dried polyimide film was peeled off from the PET substrate, and further heated at 220° C. for 10 minutes under the condition of a draw ratio of 1.0 using a small tenter facility, thereby affording a long polyimide-based film having a thickness of 25 μm and the aforementioned dimensions. The results are shown in Table 1.

### Comparative Example 1

A polyimide-based film having a thickness of 25 μm was produced in the same manner as in Example 1 except that γ-butyrolactone (GBL: moisture absorption speed per unit area: 28% by mass/h·m²) was used as a solvent in varnish production. The results are shown in Table 1.

### Comparative Example 2

A polyimide-based film having a thickness of 25 μm was produced in the same manner as in Example 1 except that dimethylacetamide (DMAc: moisture absorption speed per unit area: 40% by mass/h·m²) was used as a solvent in varnish production. The results are shown in Table 1.

TABLE 1

| | Solvent | | | | | | | | |
|---|---|---|---|---|---|---|---|---|---|
| | (moisture | | Optical | | | | Solvent | | |
| | absorption | | transmittance | | Tensile | | content | | |
| | speed [% by | Tg | [%] | | strength | Rth | [% by | Rz | Appearance |
| | mass/h · m²]) | [° C.] | 350 nm | 500 nm | [MPa] | [nm] | mass] | [μm] | characteristics |
| Example 1 | CH(19) | 181 | 1.1 | 90.5 | 90 | 55.6 | 1.2 | 0.3 | ◯ |
| Comparative | GBL(28) | 181 | 1.2 | 90.3 | 89 | 53.5 | 1.2 | 25 | X |
| Example 1 | | | | | | | | | |
| Comparative | DMAc(40) | 180 | 1.4 | 90.4 | 90 | 54.0 | 1.3 | 19 | Δ |
| Example 2 | | | | | | | | | |

As shown in Table 1, it was confirmed that the long optical films produced by the production methods of Examples had superior smoothness and good appearance because the Rz values of the surfaces of the films were small. On the other hand, the long optical films produced by the production methods of Comparative Examples were found to have irregularities in the appearance of the films and have poor appearance.

### INDUSTRIAL APPLICABILITY

The long optical film produced by the method of the present invention has high smoothness and good appearance. Therefore, the long optical film can be suitably used for various applications, for example, a substrate for a touch sensor, a material for a flexible display device, a protective film, a film for bezel printing, a semiconductor application, a speaker diaphragm, and an IR cut filter.

1. A method for producing a long optical film, the method comprising a step of preparing a varnish by dissolving a polyimide-based resin in a solvent,
wherein
the polyimide-based resin comprises a constitutional unit derived from an aliphatic diamine, and
a moisture absorption speed per unit area of the solvent is 25% by mass/h·m² or less determined by a Karl Fischer method.

2. The method according to claim 1, wherein the solvent comprises at least one selected from a group consisting of cyclohexanone and cyclopentanone.

3. The method according to claim 1, wherein the long optical film has a glass transition temperature Tg of higher than 180° C.

4. The method according to claim 1, wherein the long optical film has an optical transmittance at 350 nm of 10% or less.

5. The method according to claim 1, wherein the long optical film has an optical transmittance at 500 nm of 90% or more.

6. The method according to claim 1, wherein the long optical film has a tensile strength of more than 86 MPa.

7. A long optical film comprising a polyimide-based resin,
wherein the polyimide-based resin comprises a constitutional unit derived from an aliphatic diamine, and the long optical film has a maximum height roughness Rz defined by JIS B-0601: 2013 of 2.0 μm or less on at least one surface thereof.

8. A long optical film comprising a polyimide-based resin,
wherein the polyimide-based resin comprises a constitutional unit derived from an aliphatic diamine, and the long optical film has a maximum height roughness Rz defined by JIS B-0601: 2013 of 2.0 μm or less on a surface which has not been in contact with a substrate of the long optical film.

9. The long optical film according to claim 7, wherein the long optical film has a thickness retardation Rth of 100 nm or less.

10. The long optical film according to claim 7, wherein the long optical film has a solvent content of 3.0% by mass or less based on a mass of the long optical film.

11. The long optical film according to claim 7, wherein the polyimide-based resin comprises a constitutional unit represented by Formula (1) 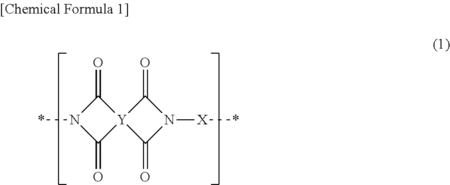
wherein X represents a divalent aliphatic group, Y represents a tetravalent organic group, and * represents a bonding hand.

12. The long optical film according to claim 11, wherein the constitutional unit represented by Formula (1) comprises, as Y, a structure represented by Formula (2) 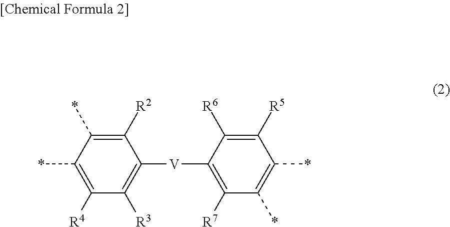
wherein R² to R⁷ each independently represent a hydrogen atom, an alkyl group having 1 to 6 carbon atoms, an alkoxy group having 1 to 6 carbon atoms, or an aryl group having 6 to 12 carbon atoms, the hydrogen atoms contained in R² to R⁷ may be each independently substituted by a halogen atom, V represents a single bond, —O—, —CH₂—, —CH₂—CH₂—, —CH(CH₃)—, —C(CH₃)₂—, —C(CF₃)₂—, —SO₂—, —S—, —CO—, or —N(R⁸)—, R⁸ represents a hydrogen atom or a monovalent hydrocarbon group having 1 to 12 carbon atoms which is optionally substituted with a halogen atom, and * represents a bonding hand.

13. The long optical film according to claim 11, wherein the polyimide-based resin contains a fluorine atom.
